(19) United States
(12) Patent Application Publication
(10) Pub. No.: US 2009/0171737 A1
(43) Pub. Date: Jul. 2, 2009

(54) Vehicle Sales Space System

(76) Inventor: Cecilio Vladimir Polanco, Santo Domingo (DO)

Correspondence Address: THE PATENT GUILD, 313 COURTNEY SPRINGS CIRCLE, WINTER SPRINGS, FL, 32708, US

(21) Appl. No.: 11/968,163

(22) Filed: Dec. 31, 2007

(51) Int. Cl. G06Q 30/00; G06F 17/00

(52) U.S. Cl. 705/8; 705/26

(57) ABSTRACT

The present invention relates to a method for managing a vehicle sales geographic location/site and a method for facilitating vehicle sales in a Vehicle Sales Space System (VSS System) by managing and organizing the flow of people, vehicles, and material through the site. The VSS System has been developed using the latest technology to provide a safe, secure, and economical way to sell a vehicle at a secure access site.

### FIELD OF THE INVENTION

The present invention relates to a method for managing a vehicle sales geographic location and a method for facilitating vehicle sales in a Vehicle Sales Space System (VSS System).

### BACKGROUND OF THE INVENTION

Buying a car in the 21^{st} Century has various dangers because car buyers and car sellers face traditional theft concerns as well as the very real potential for identify theft or other such electronic criminal activity which results from giving personal information to an unfamiliar person, giving them your money, car title, or the keys to your car.

Vehicle Sellers and Buyers have a need for conducting vehicle sales in a safe and secure location, preferably at a convenient time and date, which in turn requires the use of a method for managing a vehicle sales site to provide the desired safe, secure, and convenient location which has led to the invention of the Vehicle Sales Space System.

To address the above needs, the VSS System has been developed using the latest technology to provide a safe, secure, and economical way to sell a vehicle. The VSS System includes a System Database used for storing and manipulating data and information as well as a sales space geographical location, used for exhibiting the vehicle, providing sales support services, and conducting the sales transactions.

With regards to safety, security, and convenience, current vehicle sales methods do not provide an opportunity for the vehicle Seller to input a preferred date and geographical location a vehicle will be available for purchase or viewing. Further, current vehicle sales methods do not provide an opportunity for the vehicle Buyer to indicate a preferred date and geographical location the vehicle Buyer desires the vehicle be made available for purchase or viewing.

Well known conventional methods for vehicle sales or purchases include:
1) going into a car dealership to view its cars,
2) viewing cars on line,
3) randomly finding vehicles on parking lots or in arbitrary locations with signs indicating they are available for sale, or
4) finding vehicles through “word of mouth” from others.

These methods fail to allow a car Seller or Buyer to select and/or indicate a specific date and geographic location for conducting the vehicle sale. Further, these methods do not stress providing a safe and secure location for viewing the vehicle, conducting the sale transaction, and providing privacy and/or anonymity.

Clearly, the need exists for a car Seller or Buyer to be able to buy or sell a vehicle in a safe and secure way at a low cost which is convenient to the both parties.

The features used to provide the present invention's method for managing a vehicle sales geographic location and method for facilitating vehicle sales in a Vehicle Sales Space System are a unique combination of features used separately in a diverse variety of fields including vehicle auctions, parking lot management, scheduling systems, general sales space related patents, and subscription services related patents. As explained below, each of these usages fails to address providing the vehicle Buyer or Seller an opportunity to indicate a preferred sale date and time concurrent with indicating a safe and secure geographical location which the vehicle Buyer or Seller desires the vehicle be made available for purchase or viewing.

The patents directed at parking lot management differ from the VSS System because they do not allow a Seller to inform potential Buyers of the time and location for the viewing and sale of the vehicle. Users of the parking lot managements systems can generally view available parking spaces and can register remotely for the parking spaces, but the existing systems do not allow the users to notify others that the vehicle will be parked at the parking space at a specified time and location. Existing Parking Lot Management systems do not provide an indication a specified vehicle will occupy a specified lot space on a specified date at a specified time.

For example, U.S. Pat. No. 6,501,391 presents Internet communication of a parking lot wherein a server transmits parking lot occupancy information over the Internet. The parking lot occupancy information is capable of being reproduced by a remote display device as a real-time representation of the parking lot, indicating vacant parking spaces. When presented with the real-time representation of the parking lot, a commuter readily can locate an available parking space or decide to search for parking elsewhere.

U.S. Pat. No. 6,946,974 teaches a Web-based systems and methods for internet communication of substantially real-time parking data for a parking system which includes an internet-accessible Web server storing substantially real-time parking data associated with occupancy of a plurality of parking spaces. The parking data can be rendered by a display device running a browser application. The Web server transmits the parking data in response to a request sent from the browser application. The Web server communicates with at least one of a detector and a parking terminal configured to collect and transmit parking data.

These inventions provide parking space availability information but do not provide functionality wherein the Seller or Buyer indicates a time and geographical location wherein the vehicle shown on the webpage can be viewed and/or purchased.

The various known scheduling patents do not allow a Seller to inform potential Buyers of the time and location for the viewing and sale of the vehicle because there is no link between scheduling a meeting in general and indicating the Seller will bring the specified vehicle shown on the website to the meeting for review and sale. Generally, existing scheduling systems do not provide a correlation between an item shown on the webpage and the scheduled meeting.

For example, U.S. Pat. No. 5,289,531 teaches remote scheduling of appointments with interactivity using a caller's unit. This allows call-in scheduling but does not provide functionality wherein a Seller or a Buyer indicates a time and location a vehicle shown on a webpage can be viewed and purchased.

Vehicle auction related patents do not provide functionality wherein a Seller or a Buyer indicates time and location a vehicle shown on a webpage can be physically viewed and purchased. For example U.S. Pat. No. 5,774,873 teaches an electronic on-line motor vehicle auction and information system which allows remote users to interactively participate in motor vehicle auction sales using a personal computer. Additional user applications associated with the system permit users to access and search a system database and display data about preset motor vehicle auction dates and locations, vehicle inventory, industry news, and vehicle sales history. U.S. Pat. No. 5,664,115, is an interactive computer system to match Buyers and Sellers of real estate, businesses and other property using the internet. It aligns Buyers and Sellers but does not provide functionality wherein the Seller or Buyer indicates a time and location a vehicle shown on a website can be physically viewed and purchased.

The general sales space allocation related patents indicate where an item is located at a sales location but does not allow a Seller to inform potential Buyers of the time and location for the viewing and sale of the vehicle show on the website. U.S. Pat. No. 7,231,380 teaches an apparatus and method for providing product location information to customers in a store.

The subscription services with user cards related patents show that various subscription services such as access to a restricted site can be linked to user cards but the existing systems do not allow the users to notify others that a specified vehicle will be available for viewing at a specified time at the restricted access location. Existing subscription services patents do not provide a correlation between an item shown on the webpage and the subscribed activities. For example U.S. Pat. No. 6,363,351 teaches a subscriber registration and access control system and related methods.

There are known patent and published patent applications which address vehicle sales but fail to teach the instant invention.

Autotrader Published Patent Application Number US20030187714 teaches developing a log of a user's online product searches but does not provide an opportunity for the vehicle Seller or Buyer to input a preferred date and geographical location a vehicle will be available for purchase or viewing as provided in the present invention.

Autotrader Patent Published Patent Application Number US20040128224 teaches an online auction method but does not provide an opportunity for the vehicle Seller or Buyer to input a preferred date and geographical location a vehicle will be available for purchase or viewing as provided in the present invention. While Sellers can specify a start or duration for the time/date of the online auction or the online vehicle listing, there are no provisions for the vehicle Seller or Buyer to input a preferred date and geographical location a vehicle will be available for purchase or viewing as provided in the present invention. Autotrader Published Patent Application Number US20070185777 teaches a method and system for facilitating searches for vehicle merchants, for example by searching for languages spoken, financing options, and physical facility differentiating factors however there are no provisions for the vehicle Seller or Buyer to input a preferred date and geographical location a vehicle will be available for purchase or viewing as provided in the present invention.

U.S. Pat. No. 6,041,310 to Greenway Motors teaches a method and system for facilitating a transaction between a customer and an automobile dealership. The system includes an on-site kiosk at the car dealership including an input/display terminal and a terminal processor for formulating a multilevel customer query of automobile inventory. The query searches a storage device containing automobile data and images to return a selected inventory to the input/display device. The use of the invention includes storing customer data and selected inventory information for later access by a marketing follow-up application and a financing and insurance application. Greenway does not provide functions wherein the Seller or the Buyer indicates a time and location the vehicle shown on web can be viewed and purchased.

Further, vehicle sales support related patents such as U.S. Pat. No. 6,041,310 to Greenway Motors provide for in-store kiosks and on-line car searches but does not allow a Seller to accept input from potential Buyers on the time and location for the viewing and sale of the vehicle shown online or on the website. The Seller's or Buyer's ability to request or indicate the time and location the vehicle shown on the website will be on display at the specified location is a significant improvement over Greenway Motors '310 because Greenway Motors '310 does not address coordinating a Seller bringing in a vehicle not already on-site with a Buyer coming in to view that specific vehicle. There is clearly a need for conducting vehicle sales in a safe and secure location, preferably at a convenient time and date.

### SUMMARY OF THE INVENTION

A key element in facilitating the sale of a vehicle is the location used to allow inspection of the vehicle as well as to transfer title and ownership of the vehicle. Major factors which are important to both the vehicle Buyer and the vehicle Seller include the economics of the sale, a location which provides safety and security, and the need for privacy and anonymity in conducting the vehicle sale transaction.

The VSS System provides private car Sellers and Buyers vehicle sale support facilities generally only available to professional car Sellers such as new or used car dealerships. An extra advantage of the VSS System is that Sellers and Buyers can choose a date, time, and location for the transaction which is mutually convenient.

Additionally, the VSS System provides a very diverse and dynamic selection of car offerings which via the webpage, can be viewed based on a variety System Databases queries such as by vehicle make, model, year, and condition as well geographical location information and exhibit date/time. Since the VSS System emphasizes constant rotation of the inventory of vehicles for sale, potential Buyers are motivated to continually check the VSS System webpages and publications.

The VSS System is an asset to Buyers who seek to get the best price with the least use of time and energy and the least amount of inconvenience. Also the VSS System can be used by people of all ages and with or without physical limitations. Buyers with physical limitations can contact vehicle Sellers and/or the VSS System personnel and request special vehicle exhibition and viewing arrangements if needed.

The present invention is generally intended for use by users which include, but is not limited to, vehicle Sellers (private owners, car dealers, and auto brokers), vehicle Buyers (private purchasers and dealers), and VSS System personnel. Each user group has a set of Database system features specifically developed for the user group.

### BRIEF DESCRIPTION OF THE DRAWINGS

The invention is explained in the following description in view of the drawings:

FIG. 1 is a block diagram of the general VSS System elements

FIG. 2 is a block diagram of the VSS System Database

FIG. 3 is a layout diagram of a VSS Geographical Location and Site

FIG. 4 is a flow chart for the signup process of the VSS System

FIG. 5 is a flowchart of the space usage process of the VSS System

FIG. 6 is a flow chart of general VSS System usage

FIG. 7 is a flow chart of the methodology for determining the vehicle exhibition date, time, and location

FIG. 8 is a flow chart of example usage of the VSS System

FIG. 9 is a flow chart of Buyer usage of the VSS System

FIG. 10 is an example of a VSS Display Card

FIG. 11 is an example of a VSS Subscription Card.

### DETAILED DESCRIPTION OF THE INVENTION

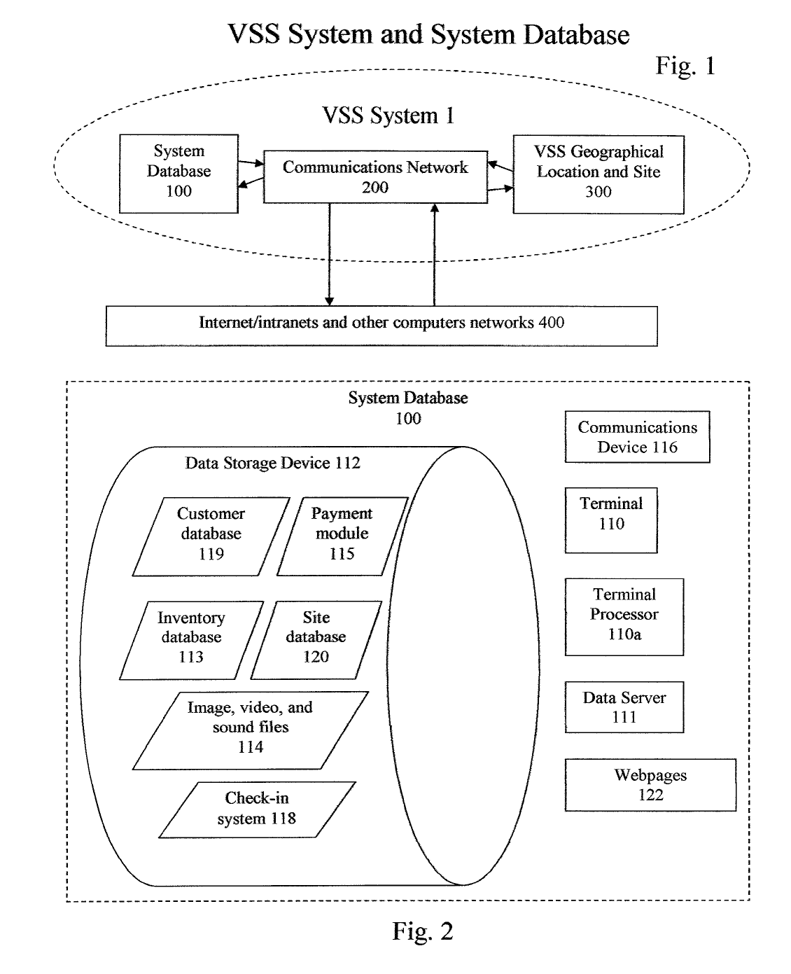

FIG. 1 generally illustrates the preferred embodiment of overall Vehicle Sales Space System 1. The Vehicle Sales Space System 1 is comprised of a System Database 100, a geographic location 300, and a communications network 200 linking the system database 100 and the geographic location 300 with the internet or other computers and computer networks 400. The communications network 200 includes but is not limited to computer communications equipment such as routers, hubs, blades, and wireless communications equipment such as personal digital assistants, wireless networking cards, satellite communications systems, and radio identification systems.

FIG. 2 illustrates the VSS System Database 100 which is comprised of a terminal 110, terminal processor 110a, a data server 111, a communications device 116, such as telephone line, and a storage device 112. The storage device 112 contains a customer database 119, an inventory database 113, a site database 120, vehicle image files 114, video and sound files 114, and a payment module 115. Customers included in the customer database 119 includes, but is not limited to, vehicle buyers, vehicle sellers, and VSS service vendors. The inventory data in the inventory database 113 includes information about each vehicle 121. The customer database 119 includes information about the vehicle sellers 500, and vehicle buyers 501. An additional component of the System Database is a check-in system 118 which is interfaced to the storage device 112. The check-in system 118 is used to track vehicles and VSS System users. Vehicles and personnel are checked into and out of the VSS Site using the check-in system 118. The VSS System Database 100 uses the check-in system 118 to manage site occupancy and usage. Access to specific areas of the VSS site is monitored using the check-in system 118. The System Database uses generally known operating systems and software programming suited for data management, and decision making such as determining schedules.

The site database 120 includes information about the geographical location 300, VSS System Administrator 502, VSS Geographic Location Manager/Site Manager 503, VSS Agent/Representatives 504, as well as support and service vendors 505. The types of information within the VSS System Database 100 includes, but is not limited to, names, addresses, subscriber identification numbers, membership numbers, personal identification numbers (PIN), VSS Site designations, lot space designations at the VSS Site, site occupancy data, site occupancy scheduling data, seller inputted data, buyer inputted data, VSS Site Manager inputted data, System Administrator inputted data, website visitor inputted data, and data generated by the System Database 100.

The System Database generates webpages 122 to present the data of the System Database 100. These webpages 122 are presented in response to database queries or are generated as a result of operation of the database system. The webpages can be viewed and accessed, as needed, across the communications network 200 and across an intranet/internet connection 201 with other computers and computer networks 400. Multiple VSS Systems sites can be linked together into a network of VSS System sites using the communications network 200.

### General System Operation

The general operation of the system will be described with reference to FIGS. 1-11. Generally, the Vehicle Sales Space System 1 is used by user groups which include: 1) vehicle Sellers, private owners, Car Dealers, and Car Brokers 500; 2) vehicle Buyers, potential Buyers, or public users 501; 3) VSS System Administrators 502; and 4) VSS Site Managers 503. Each group has varying levels of System Database 100 access which are managed by the VSS System Administrator 502 or the VSS Site Manager 503.

The VSS System 1 includes several key elements and functions interoperating in a unique manner where the management of the geographic location 300 is determined by the VSS System Database 100 which in turn establishes a schedule or date/time to exhibit vehicles at the geographic location 300 based on an input or request from either the vehicle Seller 500, or the vehicle Buyer 501, and any combination thereof. Further, the System Database 100 can be setup to determine a date to exhibit the vehicle based on alternate parameters including randomly generating a vehicle exhibition date, or applying a methodology for determining an appropriate date to exhibit vehicles at the VSS site 300.

The VSS System 1 includes the assignment of a VSS identification or membership number (VSS ID number) and a VSS Personal Identification Number (VSS PIN) to the vehicle Seller 500 and/or vehicle Buyer 501 during the subscription process. The subscription process includes, but is not limited to, the Buyer 501 or Seller 500 entering identification information into the VSS System Database or via a VSS Agent/Representative 504. Upon successful signup for the subscription VSS System Services, as determined by the then existing company practices and procedures, the Seller 500 or Buyer 501 receives a unique VSS ID number and password or private identification number (PIN) which are used to identify the Seller 500 or Buyer 501 to the VSS System 1.

### Geographic Location/Site Managers Usage of the System

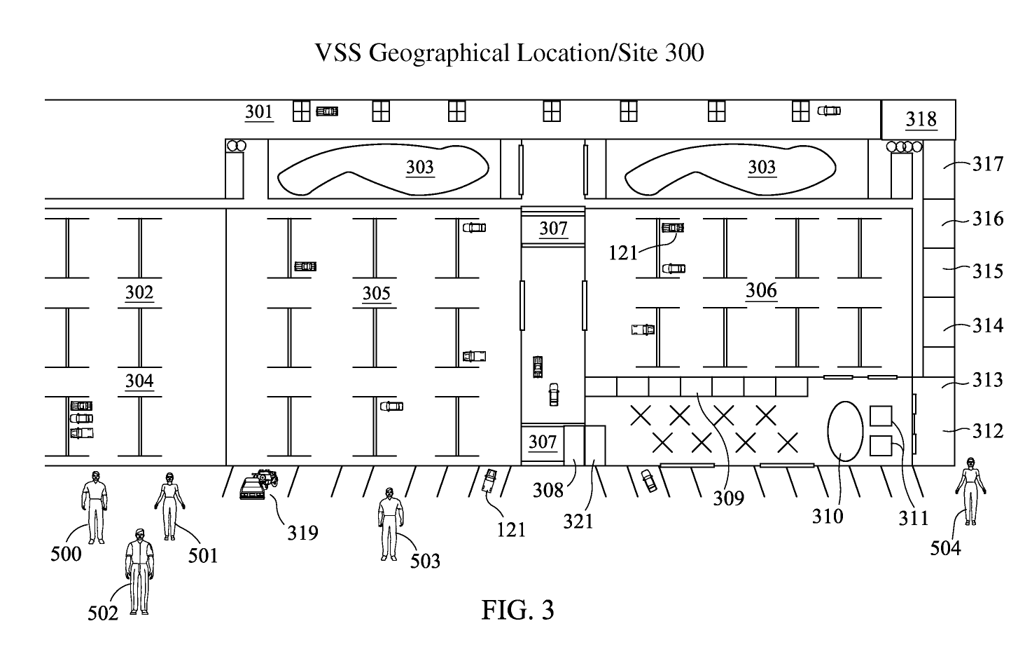

The VSS System Geographical Location 300 is the physical site established to provide the vehicle sale services of the VSS System. The geographical locations using the VSS System may or may not be restricted in their configuration since each site will need and have access to a varying set of resources. FIG. 3 presents an example layout and preferred embodiment of a geographic location/physical site 300 which has been developed to provide a safe, secure, and convenient location for conducting the sale of the vehicle.

The site 300 provides physical site areas for delivery of various vehicle sales support services such as Daily Exhibition Areas 305, Hourly Exhibition Areas 306, Long Term Exhibition Areas 304, Other Parking Areas 302, a security center 308, general auto maintenance facilities 318, a Test Drive Track 303, emergency vehicle towing service 319, a car wash area 301, an administrative/office assistance area 312, private meeting areas 309, bathrooms 321, waiting areas 309, workspace/counters 311, refreshment areas 317, 316, 315, and areas for services for persons with disabilities, among other things. Using the above physical facilities, the VSS geographic location 300 provides a variety of services such as: general mechanic services, vehicle washing and detailing, emergency services such as vehicle towing or first aid, vehicle repairs, food and beverages, private salons for conducting the sale, vehicle test drives in a secure location, controlled access areas, and waiting areas.

The vehicle sale support services of the VSS geographic location 300 aid both the Seller 500 and Buyer 501 in completing the transaction, and therefore either the Buyer or Seller can make use of the vehicle sale support services while the other party is unavailable.

A key function of the VSS geographical location 300 is to manage and organize the flow of people, vehicles, and material through the site 300 consistent with the applicable VSS System Services. Since areas of the site 300 are designated for a variety of purposes as described above, the VSS Geographic Location Manager/Site Manager 503 and VSS System Administrator 502 use the VSS System Database 100 to coordinate the delivery of the VSS System Services and the sales support services.

The management of the vehicle Seller's 500 and Buyer's 501 unique needs during the usage of the VSS site 300, and the coordination of a variety of support vendors 503 presents challenges which have resulted in the development of the present invention.

The spaces at the VSS geographical location 300 include Daily Exhibition Areas 305, Hourly Exhibition Areas 306, Long Term Exhibition Areas 304, and Other Parking Areas 302. Vehicles in the Long Term Exhibition Areas 304 generally are not rotated for exhibition in the same manner as the vehicles in the Daily Exhibition Areas 305 and Hourly Exhibition Areas 306. Vehicles in the short-term Daily Exhibition Areas 305 and Hourly Exhibition Areas 306 are rotated in and out of the exhibit area on a regular schedule, for example monthly, weekly, daily, hourly or any portion of the preceding as needed. Costs and rates vary depending on the duration the vehicles will be exhibited, among other things. Vehicles which remain in an area beyond the agreed upon time may be charged additional fees or otherwise relocated as needed to ensure efficient operation of the VSS System 1 and the Site 300. The maximum and minimum number of exhibition days may be established as needed.

The operation of a preferred embodiment of the present invention will now be described with reference to FIGS. 1-11. During operation of the VSS site 300 the method for managing a vehicle sales geographic location in a Vehicle Sales Space System comprises providing a vehicle sale space geographic location 300; a Seller 500 subscribing to a Vehicle Sales Space System Database 100 and providing vehicle 121 and Seller information to the System Database 100; a Buyer 501 subscribing to the Vehicle Sales Space System Database 100 and providing Buyer identification information to the System Database 100; the Seller 500 or Buyer 501 providing a requested date, time, and location for the vehicle 121 to be displayed at the vehicle sale space geographic location 300; using the requested date, time, and location and the System Database 100 to determine and schedule an appropriate date, time and location the vehicle 121 is to be displayed at the vehicle sale space geographic location 300; providing on a webpage 122 vehicle 121 information, Seller 500 information, and the date, time, and location the vehicle 121 will be displayed at the vehicle sale space geographic location 300.

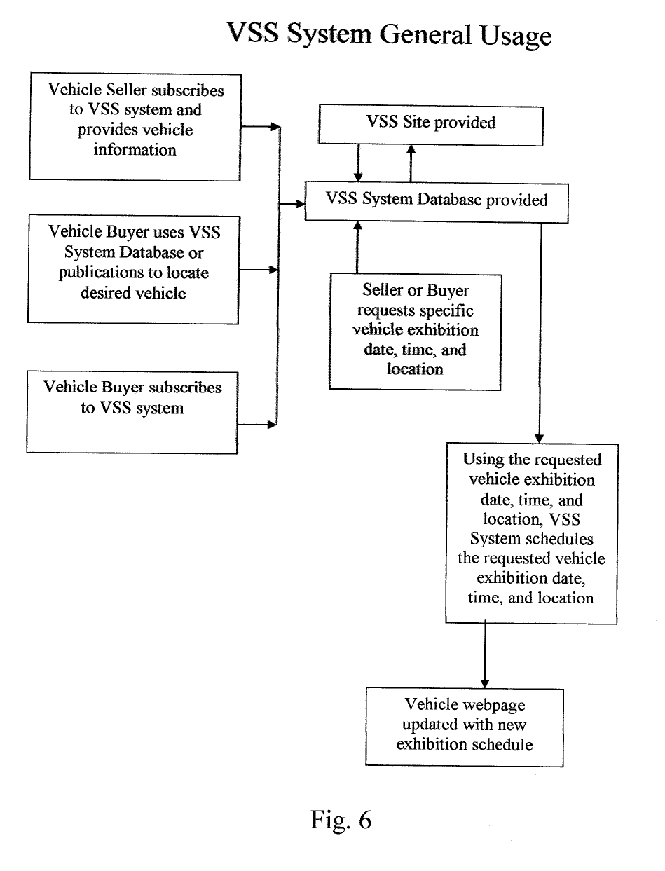

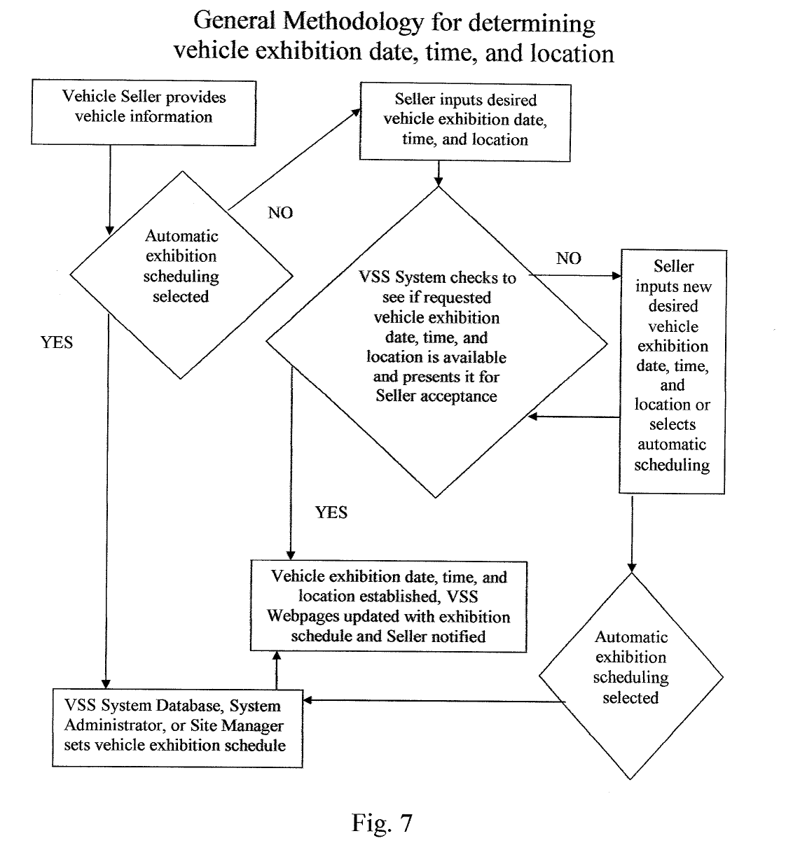

As shown in FIGS. 6 and 7, in the preferred embodiment of the present invention the System Database 100 uses the vehicle exhibition request time and location provided by the Seller 500 to determine when the vehicle will be displayed or exhibited at the vehicle sale space geographic location 300. The System Database 100 maintains data records of the site occupancy as well as a schedule of future site occupancy. The site occupancy data includes, but is not limited to, the number and types of sales spaces at the site, such as the number of sales spaces in the Daily Exhibition Areas 305, the number of sales spaces in the Hourly Exhibition Areas 306, the number of sales spaces in the Long Term Exhibition Areas 304, and the number of sales spaces in the Other Parking Areas 302. By comparing the type and availability of the sales space requested by the Seller or Buyer against the site occupancy data as well the schedule of future site occupancy, the System Database 100 selects the sales space whose date, time, and location most closely matches the vehicle exhibition date, time, and location requested by the Seller 500 or Buyer 501.

As shown in FIG. 7, once a date, time, and location for the exhibition of the vehicle at the VSS site is determined, the vehicle Seller is notified of the approved vehicle exhibition date, time, and location and provided an opportunity to accept or reject the approved vehicle exhibition date, time, and location. If the vehicle Seller accepts the approved vehicle exhibition date, time, and location the webpages associate with the vehicle are updated to indicate the vehicle exhibition schedule. If the vehicle Seller rejects the approved vehicle exhibition date, time, and location the Seller can specify an alternate vehicle exhibition date, time, and location. The Seller can also iteratively enter an alternate vehicle exhibition date, time, and location request until the Seller accepts the approved vehicle exhibition date, time, and location provided by the System Database. Additionally, the Seller can switch modes and allow the System Database, System Administrator, or Site Manager selects the date, time, and location for the exhibition of the vehicle at the VSS site without the Seller needing to accept the approved date, time, and location for the exhibition of the vehicle.

In an alternate embodiment of the present invention, as shown in FIG. 7, the System Database 100 can generate a vehicle exhibition date, time, and location independently of any initial vehicle exhibition date, time, and location requested by the Seller or Buyer. In this embodiment, for example purposes only, when the Seller reserves the space for vehicle exhibition, the System Database 100, the VSS System Administrator 502, or the VSS Site Manager 503 selects the date, time, and location for the exhibition of the vehicle at the VSS site. If the initially generated vehicle exhibition date, time, and location becomes unavailable, for whatever reason, the System Database 100, the VSS System Administrator 502, or the VSS Site Manager 503, can select an alternate available exhibition date, time, and location nearest to the initially generated exhibition date, time, and location. The Seller is notified of the vehicle exhibition date, time, and location and the corresponding webpages are updated. In this mode of operation, the Seller does not provide an initial exhibition date, time, and location.

### Vehicle Seller Usage of the System

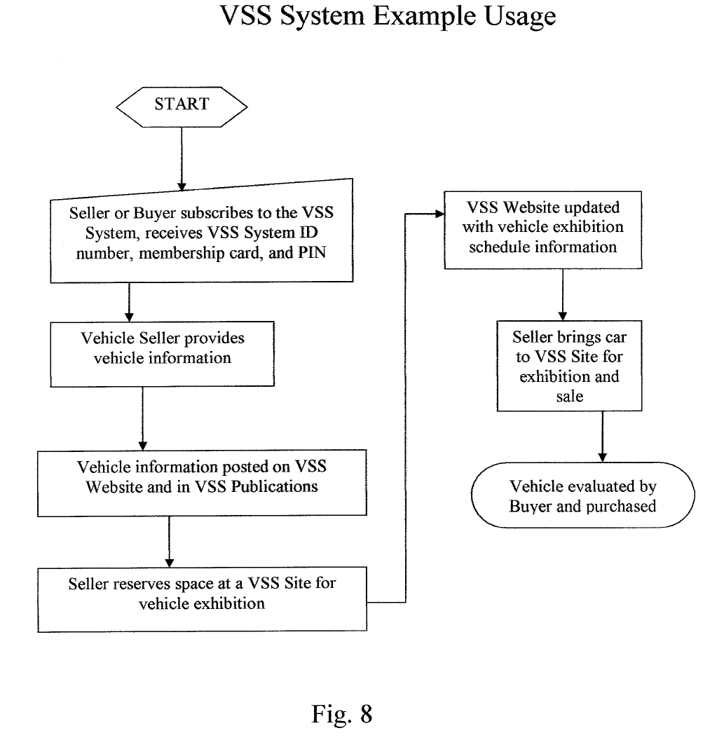

As shown in FIG. 8, the subscription process includes, but is not limited to, the Seller 500 providing personal identification information and vehicle information such as make, model, year, condition, title status, etc. Upon successful signup for the subscription VSS System services, as determined by the then existing VSS System practices and procedures, the Seller 500 receives a unique password or private identification number (PIN) and membership or subscription number that identifies the Seller 500 to the VSS System Database 100.

When subscribing to the VSS System 100, subscribed Sellers receive basic services such as car wash coupons, locally (on-site) available services, sales assistance, towing assistance, and emergency services. The Seller can request/purchase additional services beyond the basic subscription services or may be able to substitute additional services for some of the basic subscription services. A limited number of friends and family members of a Seller can also use the VSS sales assistance and support, for example they can use the cafeteria while the Seller conducts the sale transaction. Additionally, subscribers will receive promotional material if available and appropriate. The availability of specific services or items is determined by the local VSS geographical location. Sellers can use multiple VSS geographic locations consistent with the Sellers VSS System subscription/membership.

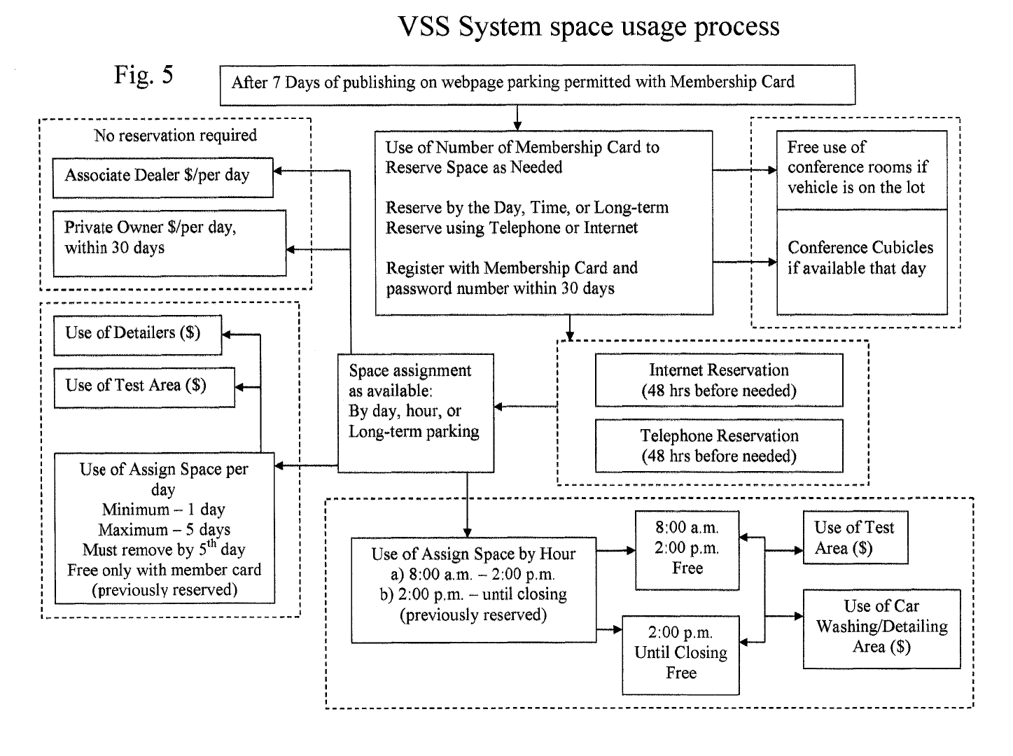

As shown in FIG. 5, the Seller can use the VSS ID number and PIN to access the VSS System via phone or internet to setup a vehicle exhibition date, time, and location, to send and retrieve email and voice messages within the VSS System, or to use the various VSS System support services.

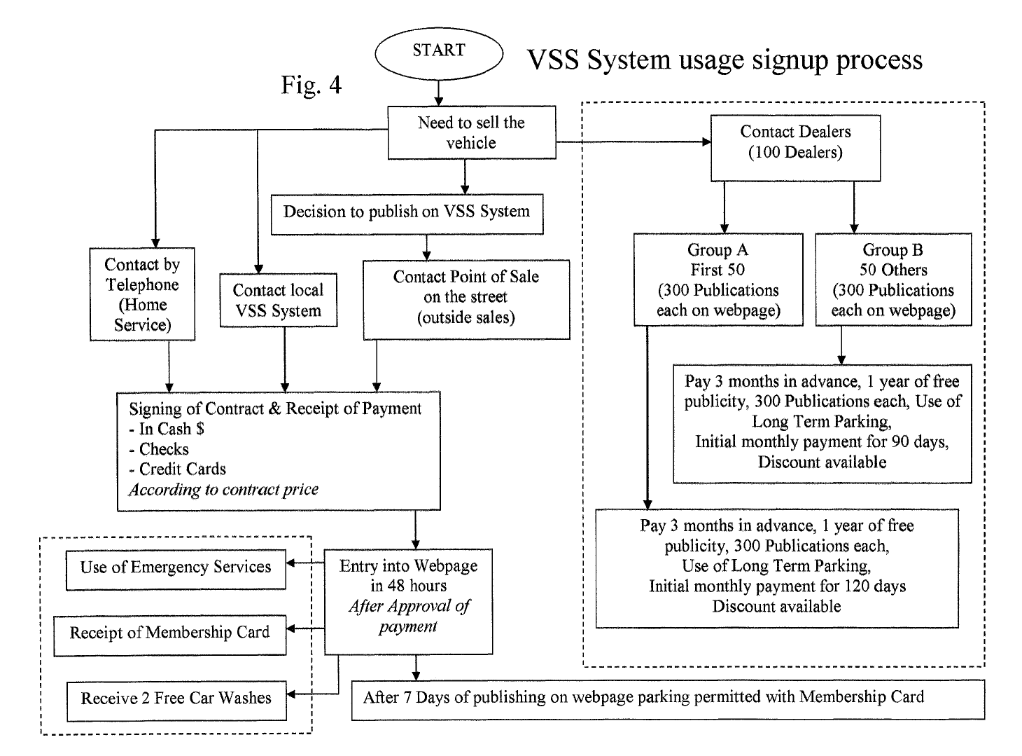

FIGS. 4 and 5 present an exemplary usage of the VSS System by a private car Seller which includes, as part of the basic subscription service, 30 days publication of the vehicle on the VSS System website, 6 vehicle photos, and a Seller identification card which provides access to the VSS geographical location and indicates additional services the Seller has signed up to receive.

Once a date, time, and location for the exhibition of the vehicle is determined using any of the methods discussed above, the webpages for the vehicle are updated with the information and the Seller takes the vehicle to the VSS site as scheduled.

The Seller can choose to limit contact with Buyers and only exhibit the vehicle as scheduled, or the Seller can indicate on the webpage that Buyers can request an alternate date, time, and location for the exhibition of the vehicle.

The VSS System is designed to allow the Seller a range of safety and security options including the ability to communicate with the Buyer anonymously. The VSS System allows the Seller and Buyer to communicate using their VSS System ID information, rather than their actual personal information. For example, the Seller can indicate the car sale price is a fixed price and chose to respond only to Buyers willing to pay the requested sale price. Alternatively, the Seller can indicate the price of the vehicle is negotiable and request potential Buyers make an offer after reviewing the vehicle at the VSS geographic location.

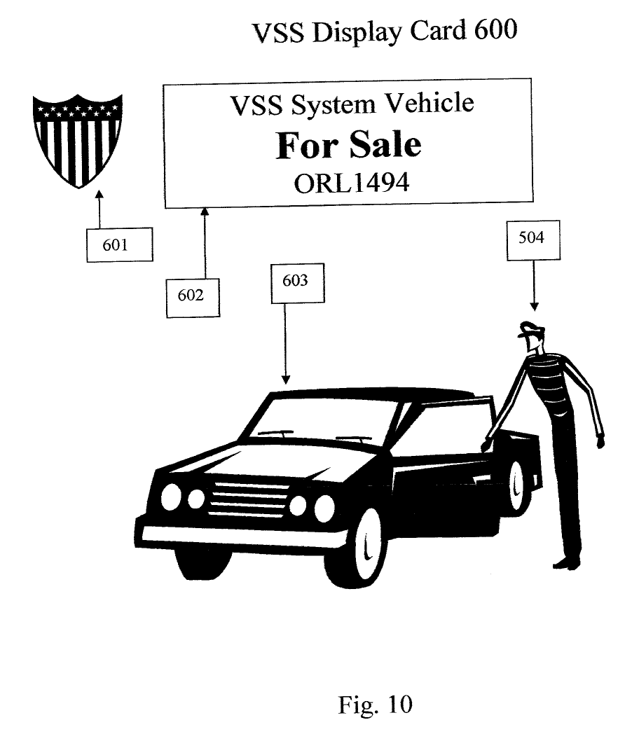

If the Seller 500 so desires, a VSS Agent/Representative 504 can conduct the demonstration of the vehicle, as shown in FIG. 10, including chaperoning the Buyer while the Buyer is driving the vehicle at the VSS Test Drive Track and being evaluated for purchase by the Buyer. The Seller can wait anonymously in other locations at the VSS Site while the VSS Agent/Representative assists with the vehicle sale, or the Seller can drop off the vehicle, leave the VSS site, and return at the end of the vehicle exhibition period. The above services are especially useful and unique. Sellers can drop off their vehicle and return to work while the VSS Agent/Representative assists with the vehicle sale and the Seller will only be contacted if needed. At any time during the vehicle sale process the Seller can provide documentation and information, as needed, and the VSS Agent/Rep will convey the documents and information to Buyers when appropriate.

Sellers can decide how much personal information to reveal and can avoid giving out their own private information such as their phone number or home or work address.

Sellers can leave the vehicle at the geographic location for exhibition for a set time period, such as 5 days. While at the VSS site the Seller can use a variety of services available, as shown in FIG. 3 such as getting the car washed, having an auto mechanic inspect and/or repair the vehicle, or get refreshments.

### Vehicle Buyer Usage of the System

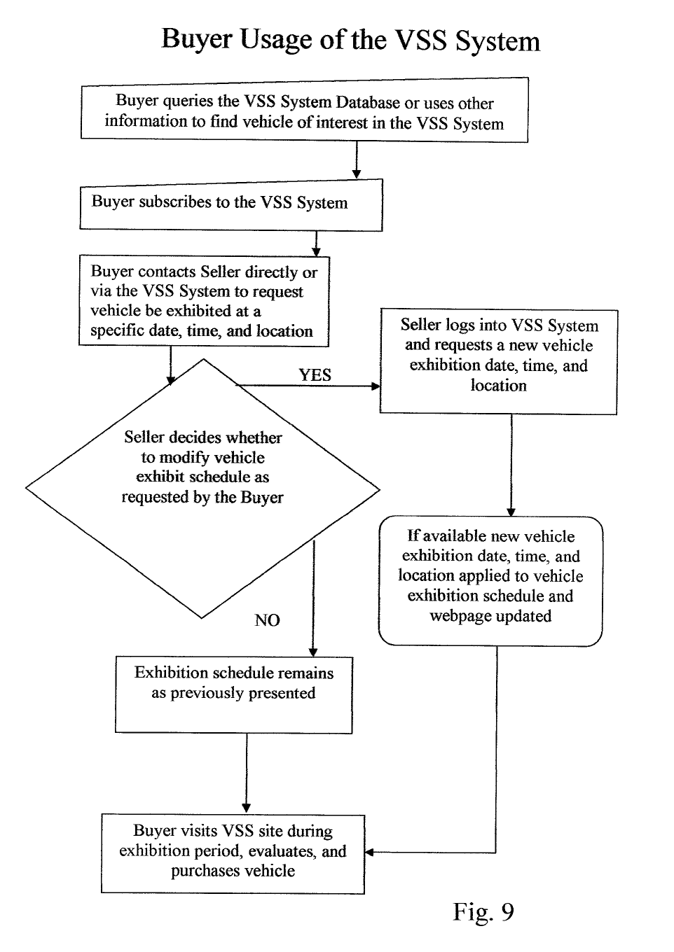

As shown in FIG. 9, vehicle Buyer 501 system usage generally begins with the Buyer 501 reviewing information on vehicles offered for sale either on the VSS Webpages or in VSS Publications. Subscription usage by the Buyer 501 of the VSS System 1 begins with the assignment of a VSS identification or membership number (VSS ID number) and a VSS Personal Identification Number (VSS PIN) to the vehicle Buyer 501 during the subscription process. The subscription process includes, but is not limited to, the Buyer 501 entering identification information into the VSS System 1. Enhanced subscription methods and Buyer screening can be used if desired. Upon successful signup for the subscription VSS System services, as determined by the then existing VSS System practices and procedures, the Buyer 501 receives a unique password or private identification number (PIN) that identifies the Buyer 501 to the VSS System 1.

The Buyer receives the basic subscription services in effect at the time the Buyer subscribes. The Buyer can request additional services beyond or where feasible, in place of basic subscription services. Buyers can use multiple VSS geographic locations consistent with the Buyers VSS System subscription/membership.

The buyer can use the VSS System webpages and/or publications or other information to locate a desired vehicle. The VSS webpages and publications provide information identifying the vehicle and indicate when and where the vehicle will be exhibited.

Using the Seller and vehicle identification information, the Buyer can contact the Seller using the VSS System, by emailing or by calling in to the VSS System. The Buyer can send requests for a specific vehicle exhibition date, time, and location (or a range of dates, times, and locations) to the Seller via the VSS System Database 100. The Seller can enter the Buyer requested vehicle exhibition date, time, and location as described above and once the Seller accepts the reservation determined by the VSS System, the Buyer can be contacted and informed of the actual vehicle exhibition information by email or phone call via the VSS System. The Buyer can also provide personal contact information and request to be contacted directly.

Potential Buyers (understood to be the same as Buyers for the purposes of this invention) who have seen the vehicle can contact the Seller and make an offer or ask follow-up questions about the vehicle. The communication between the Seller and the Buyer remains as anonymous as both parties desire because the Buyer and Seller decide how much of their personal information is to be made available to the other party. When needed, Buyers can test the vehicle in a secure area. The VSS System's secure Test Drive Track is a unique asset which is not available to most car Buyers or Sellers even if they are purchasing a vehicle from a new or used car dealership. For the vehicle Seller, there is great peace of mind in knowing the potential Buyer driving the car is restricted in where the car can be taken.

When vehicles are in the exhibition area, Buyers can see and inspect the vehicles but the vehicles can only be turned on by authorized personnel, such as the vehicle Seller or a designated VSS Agent/Representative. For example, vehicles can only be test driven by having the vehicle Seller or a designated VSS Agent/Representative in the vehicle with the Buyer and can only be driven in the designated area. There is also peace of mind in having a VSS Agent/Rep chaperone the potential Buyer because the Seller can avoid taking car rides with strangers.

Another alternate embodiment of the present invention provides a method for facilitating vehicle sales in a Vehicle Sales Space System 1 comprising: a Buyer 501 using a System Database 100 to request a date, time, and location for a vehicle 121 to be displayed at a vehicle sale space geographic location 300; using the Buyer 501 requested date, time, and location and the System Database 100 to determine a time and location the vehicle 121 is to be displayed at the vehicle sale space geographic location 300, and providing on a webpage 122 vehicle information, information of the Seller 500 of the vehicle 121, and the date, time, and location the vehicle 121 will be displayed at the vehicle sale space geographic location 300.

Another alternate embodiment of the present invention provides a method for facilitating vehicle sales in a Vehicle Sales Space System comprising a Seller 500 subscribing to the System Database 100 and providing vehicle 121 and Seller 500 information to the System Database 100; a Buyer 501 subscribing to the System Database 100 and providing identification information to the System Database 100, the Buyer 501 or Seller 500 providing a requested date, time, and location for the vehicle 121 to be displayed at the vehicle sale space graphic location 300, using the requested date, time, and location and the System Database 100 to determine and schedule an actual date, time, and location the vehicle 121 is to be displayed at a vehicle sale space geographic location 300; and providing on a webpage the vehicle information, Seller information, and the date, time, and location the vehicle will be displayed at the vehicle sale space geographic location 300.

Yet another alternate embodiment of the present invention provides a method for facilitating vehicle sales in a Vehicle Sales Space System comprising: providing vehicle and Seller 500 information to a vehicle sale space system Database 100; using the System Database 100 to determine and schedule a date, time, and location the vehicle is to be displayed at a vehicle sale space geographic location; and providing on a webpage vehicle information, Seller 500 information, and the date, time, and location the vehicle will be displayed at the vehicle sale space geographic location.

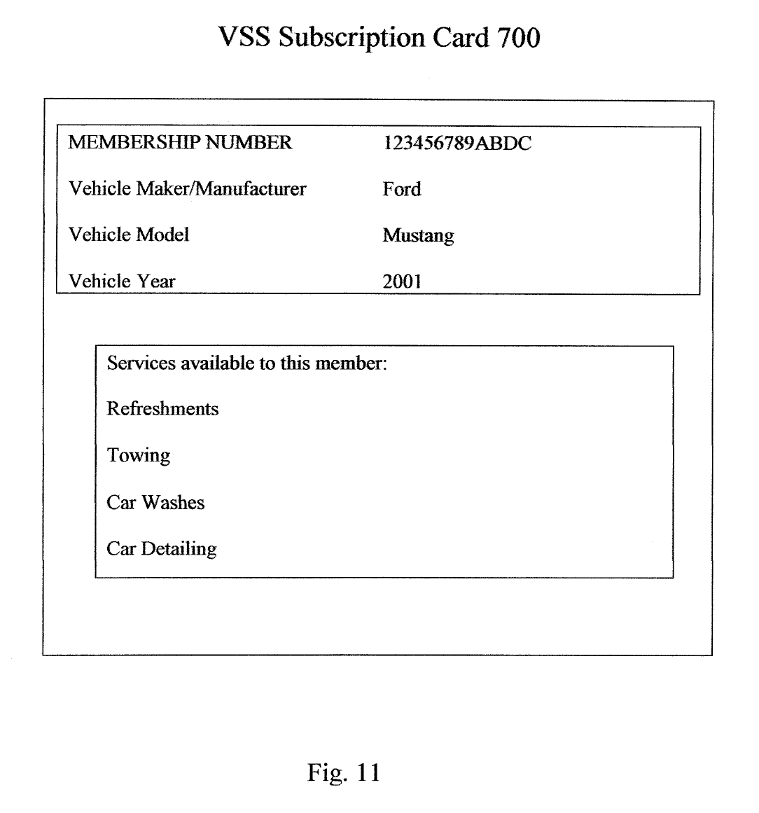

The VSS System also includes a Subscription Card 700, see FIG. 11, which vehicle Buyers and Sellers receive upon subscribing to the VSS System. The Subscription card information can include, but is not limited to, the make, model, color, and year of a Sellers vehicle, a membership number or VSS ID number, the services available to the subscriber, the services the subscriber has used, and other indicia which supports subscription services.

The vehicles of the VSS System are publicized online in VSS System webpages and/or on the internet as well as in a publication which is distributed at least through out the local community The VSS System services are expected to be promoted and advertised at a variety of public locations such as shopping malls, and remote locations and events. Sellers can subscribe to the VSS System and provide their own photographs of the vehicle or arrangements can be made to have a VSS Agent/Representative take photos of the vehicle.

The VSS System Publications also includes Display Cards 600, see FIG. 10, used to publish information about vehicles available in the VSS System. Sellers can place the Display Card in the vehicle window to inform Buyers where to get more information and to let the Buyers know the vehicle is available through the VSS System. The display cards can include, but are not limited too a logo or source indicia 601 and a reference code 602. Logos used may vary and indicate a specific VSS System site. The reference code can be used by a Buyer to locate the specific vehicle in the VSS System Database. For example a reference code of “ORL1494” indicates the vehicle is for sale through the VSS System and more info can be found in the VSS System Database (such as via the webpages or other methods) where the “ORL” indicates the vehicle is available for review at an Orlando area VSS Site and the desired information is at reference record 1494. Buyers seeing these Display Cards can obtain vehicle information and vehicle exhibition schedule information without the need to perform a database search since the Display Card directly identifies the vehicle of interest within the VSS System.

Car Dealers are invited to subscribe to the VSS System. Car Dealers and private vehicle Sellers receive the same basic subscription services. Additionally, car Dealers may receive pricing discounts, for example for subscribing to the service for more than 90 days or for paying for 120 days of service in advance, as shown in FIG. 4.

The term Vehicle Sales Space System 1 (“VSS System”) refers to the present invention in general. The term “vehicle” as used herein is intended to have the same meaning as the term automobile as well as to include cars, trucks, vans, sports/utility vehicles and other methods of transportation including ships, boats, jet skis, airplanes, helicopters, and trains.

While various embodiments of the present invention have been shown and described herein, such embodiments are provided by way of example only and it is not intended that the invention be limited by the various embodiments presented.

The invention claimed is:

1. A method for managing a vehicle sales geographic location in a vehicle sales space system comprising:
providing a vehicle sale space geographic location;
a Seller subscribing to a Vehicle Sales Space System Database and providing vehicle and Seller information to the System Database;
a Buyer subscribing to the Vehicle Sales Space System Database and providing Buyer identification information to the system Database;
the Buyer or Seller providing a requested date, time, and location for the vehicle to be displayed at the vehicle sale space geographic location;
using the requested date, time, and location and the System Database to determine and schedule a date, time, and location the vehicle is to be displayed at the vehicle sale space geographic location; and
providing on a webpage vehicle information, Seller information, and the date, time, and location the vehicle will be displayed at the vehicle sale space geographic location.

2. The method of claim 1 wherein:
the Buyer provides the requested date, time, and location for the vehicle to be displayed at the vehicle sale space geographic location; and further including
using the Buyer requested date, time, and location and the System Database to determine a date, time, and location the vehicle is to be displayed at the vehicle sale space geographic location.

3. The method of claim 1 further including:
wherein the VSS System Database first uses a date, time, and location the vehicle is to be displayed at the vehicle sale space geographic location provided by the Seller to determine a vehicle exhibition schedule,
wherein due to non-availability of the Seller requested date, time, and location the vehicle is to be displayed at the vehicle sale space geographic location, the VSS System Database generates an alternate date, time, and location the vehicle is to be displayed at the vehicle sale space geographic location.

4. The method of claim 1 further including wherein:
the VSS System Database first uses a date, time, and location the vehicle is to be displayed at the vehicle sale space geographic location provided by the Buyer to determine a vehicle exhibition schedule,
wherein due to non-availability of the Buyer requested date, time, and location the vehicle is to be displayed at the vehicle sale space geographic location, the VSS System Database generates an alternate date, time, and location the vehicle is to be displayed at the vehicle sale space geographic location.

5. The method of claim 2 further including:
displaying the vehicle at the sale space geographic location at the time/location determined by the system Database.

6. The method of claim 2 wherein:
the buyer or seller receives subscription services selected from the group consisting of cafeteria services, towing services, vehicle exhibition area reservation services, car washing, car detailing, private meeting area access, and work space usage, general automotive maintenance services, administrative assistance, VSS Agent/Representative sales assistance, and vehicle test track use.

7. The method of claim 1 further including:
providing multiple vehicle sales space geographic locations which are linked together using a communications network.

8. The method of claim 1 further including providing vehicle information on a display card and Seller or Buyer information on a subscription card.

9. The method of claim 1 wherein the sale space geographic location is a secure location with access control.

10. The method of claim 1 wherein the vehicle sale space geographic location includes areas designated for hourly vehicle exhibition periods, daily vehicle exhibition periods, and long term vehicle exhibition periods.

11. A method for facilitating vehicle sales in a Vehicle Sales Space System comprising:
a Seller subscribing to a Vehicle Sales Space System Database and providing vehicle and Seller information to the system Database;
a Buyer subscribing to the Vehicle Sales Space System Database and providing identification information to the system Database;
the Buyer or Seller providing a requested date, time, and location for the vehicle to be displayed at the vehicle sale space geographic location;
using the requested date, time, and location and the system Database to determine and schedule a date, time, and location the vehicle is to be displayed at a vehicle sale space geographic location; and
providing on a webpage the vehicle information, Seller information, and the date, time, and location the vehicle will be displayed at the vehicle sale space geographic location.

12. The method of claim 11 wherein the buyer or seller receives subscription services selected from the group consisting of cafeteria services, towing services, vehicle exhibition area reservation services, car washing, car detailing, private meeting area access, and work space usage, general automotive maintenance services, administrative assistance, VSS Agent/Representative sales assistance, and vehicle test track use.

13. The method of claim 11 further including wherein the VSS System the VSS System Database first uses a date, time, and location the vehicle is to be displayed at the vehicle sale space geographic location provided by the Seller to determine a vehicle exhibition schedule,
wherein due to non-availability of the Seller requested date, time, and location the vehicle is to be displayed at the vehicle sale space geographic location, the VSS System Database generates an alternate date, time, and location the vehicle is to be displayed at the vehicle sale space geographic location.

14. The method of claim 11 further including wherein:
the VSS System Database first uses a date, time, and location the vehicle is to be displayed at the vehicle sale space geographic location provided by the Buyer to determine a vehicle exhibition schedule,
wherein due to non-availability of the Buyer requested date, time, and location the vehicle is to be displayed at the vehicle sale space geographic location, the VSS System Database generates an alternate date, time, and location the vehicle is to be displayed at the vehicle sale space geographic location.

15. A method for facilitating vehicle sales in a Vehicle Sales Space System comprising:
a buyer using a System Database to request a date, time, and location for a vehicle to be displayed at a vehicle sale space geographic location;
using the Buyer requested date, time, and location and the System Database to determine a time and location the vehicle is to be displayed at the vehicle sale space geographic location.
providing on a webpage vehicle information, information of a Seller of the vehicle, and the date, time, and location the vehicle will be displayed at the vehicle sale space geographic location.

16. The method of claim 15 wherein the Buyer or Seller subscribes to the VSS System and receives subscription services selected from the group consisting of cafeteria services, towing services, vehicle exhibition area reservation services, car washing, car detailing, private meeting area access, and work space usage, general automotive maintenance services, administrative assistance, VSS Agent/Representative sales assistance, and vehicle test track use.

17. The method of claim 15 further including wherein:
the VSS System Database first uses a date, time, and location the vehicle is to be displayed at the vehicle sale space geographic location provided by the Buyer to determine a vehicle exhibition schedule,
wherein due to non-availability of the Buyer requested date, time, and location the vehicle is to be displayed at the vehicle sale space geographic location, the VSS System Database generates an alternate date, time, and location the vehicle is to be displayed at the vehicle sale space geographic location.

18. The method of claim 15 wherein the sale space geographic location is a secure location with access control including a check-in system to track vehicles and personnel.

19. The method of claim 15 further including providing multiple vehicle sales space geographic locations which are linked together using a communications network.

20. The method of claim 15 wherein the vehicle sale space geographic location includes areas designated for hourly vehicle exhibition periods, daily vehicle exhibition periods, and long term vehicle exhibition periods.
